(19) United States
(12) Patent Application Publication
(10) Pub. No.: US 2013/0088514 A1
(43) Pub. Date: Apr. 11, 2013

(54) MOBILE ELECTRONIC DEVICE, METHOD AND WEBPAGE FOR VISUALIZING LOCATION-BASED AUGMENTED REALITY CONTENT

(71) Applicants: Philipp Breuss-Schneeweis, Hallein (AT); Andreas Gstoll, Salzburg (AT)

(72) Inventors: Philipp Breuss-Schneeweis, Hallein (AT); Andreas Gstoll, Salzburg (AT)

(73) Assignee: Wikitude GmbH, Salzburg (AT)

(21) Appl. No.: 13/563,672

(22) Filed: Jul. 31, 2012

Related U.S. Application Data
(60) Provisional application No. 61/543,320, filed on Oct. 5, 2011.

(51) Int. Cl. G09G 5/00

(52) U.S. Cl. 345/633

(57) ABSTRACT

A mobile electronic device comprises a display, a processor controlling the display, a memory for storing data and software code, and a data interface for establishing data connection to a server. It further comprises a camera configured to generate video data, a position sensor configured to generate position data, a digital compass configured to generate directional data, and an inclination sensor configured to generate inclination data. The process is configured to retrieve video data from the camera, to generate a video stream from the retrieved video data and to display the video stream in a window representation in the display. The processor is further configured to enhance the window representation with augmented reality objects derived from the position data, the directional data and the inclination data.

### CROSS-REFERENCE TO RELATED APPLICATIONS

This application claims the benefit of U.S. Provisional Application No. 61/543,320, filed on Oct. 5, 2011, the disclosure of which is hereby incorporated by reference in its entirety.

### BACKGROUND OF THE INVENTION

The present invention generally relates to a mobile electronic device. The present invention also relates to a method for visualizing location-based augmented reality content in a display of a mobile electronic device. Finally, the present invention relates to a webpage being loadable into the mobile electronic device.

Electronic devices increasingly include displays as part of the user interface of the device with the ability to display graphical data such as video streams, photos, 2-dimensional and 3-dimensional images as well as text elements.

As may be appreciated, displays are employed in a wide array of mobile electronic devices, including cellular phones, portable media players as well as various handheld computing devices. As these devices have become more popular, there has been an increase in demand for the type and amount of functionality that displays in these devices supply.

For instance, embedding augmented reality content within a mobile webpage has been identified as a kind of functionality desired by many users of said electronic devices.

“Augmented reality” (abbreviated ‘AR’) is commonly understood as overlaying a live video stream with computer generated data called “content” and displaying the resulting video signals in a display of a mobile electronic device. The content may e.g. comprise text elements, images, 3-dimensional models or any other kind of information adapted for graphical representation in the display of the device. These overlays of content provide an augmented reality interface in which the overlays virtually interact with real-world objects. For example, the content may comprise information about landmarks, historic sites, or other scenic locations actually visible by a camera of the electronic device and is overlaid upon the landmarks, historic sites, or other scenic locations visible in the video stream provided by the camera.

To make content objects appear in a live video stream on top of a real world object, a mechanism called “tracking” is used. There are two techniques of augmented reality tracking:

A) In “marker-based” tracking a computer software does not only stream camera image frames as a live video stream to a display, but at the same time analyzes the live video stream to detect predefined patterns. If such a pattern is recognized, content related to this pattern is overlaid on top of the pattern in the video stream. If the device is moved, e.g. rotated, which is recognized from changes of the pattern in the video stream, the software adapts the position of the content within the display accordingly, such that it still remains on top of the pattern, as long as the pattern is visible in the display.

B) “Location-based” tracking comprises reading the geographical position of the mobile electronic device (latitude, longitude—by GPS or WiFi), compass values, accelerometer sensor values and orientation sensor values to determine objects visible in the field of view of a built-in camera at a certain moment in time and to overlay recognized objects in the live camera video stream with content related to these objects.

The present invention uses location-based augmented reality tracking, which hereinafter is also referred to as location-based augmented reality.

Hitherto, location-based augmented reality has only been implemented in so called “apps” meaning software applications which are downloadable from a remote server into the memory of an electronic device. So far, only “apps” offered access to built-in sensors of the electronic device, such as a camera, GPS and/or WiFi modules, a compass, an orientation sensor, an accelerometer. It has not been possible to integrate location-based augmented reality within webpages. Instead, location-based augmented reality content has been usually displayed in a full screen camera view, allowing only limited possibilities to interact with the augmented reality content. However, these limitations of known augmented reality techniques in mobile electronic devices were found to be a drawback in the usability of modern mobile electronic devices.

Thus, there is still a need for better techniques of implementing location-based augmented reality in mobile electronic devices.

### SUMMARY OF THE INVENTION

In a first aspect of the present invention a mobile electronic device, such as a cellular phone, a portable media player or a handheld computing device, is provided comprising a display, a processor controlling the display, at least one memory configured to store data and software code to be executed by the processor, at least one data interface configured to establish data connection to a server, a camera configured to generate video data, a position sensor, e.g. a GPS module, configured to generate position data; a digital compass configured to generate directional data representative for the compass direction of the mobile electronic device, and an inclination sensor configured to generate inclination data of the mobile electronic device. Preferably, the mobile electronic device comprises a housing accommodating the processor, the at least one memory, the at least one data interface, the camera, the position sensor, the digital compass and the inclination sensor.

In a second aspect of the present invention a method for visualizing location-based augmented reality content in a display of the above mobile electronic device is provided. This method may be implemented by means of program code running in the mobile electronic device.

In a third aspect of the present invention a webpage being configured to be loaded and executed in the above mobile electronic device is provided.

According to all three aspects of the invention the processor is configured to load the webpage from the server into the memory and to run a client program being stored in the memory. The client program is configured to execute instructions contained in the webpage, which instructions comprise causing the processor to retrieve video data from the camera, to generate a video stream from the retrieved video data and to display the video stream in a window representation in the display. Said instructions further comprise causing the processor to retrieve position data from the position sensor, directional data from the digital compass and inclination data from the inclination sensor and to enhance the window representation with augmented reality objects derived from the retrieved position data, directional data and inclination data. The augmented reality objects may comprise at least one of text elements, 2-dimensional graphical objects and 3-dimensional graphical objects.

Compared to location-based augmented reality implemented by means of “apps” the present invention offers open software design and avoids the necessity for publishing approvals. It eases development of webpages since standard programming languages can be used. Further, it overcomes the drawback of “apps” which have to be separately developed for different operating systems platforms and are usually written in proprietary programming languages by using proprietary set of software tools provided for each operating systems.

“Apps” are generally provided by specific “app store providers” which demand a share of typically 30% of the price of “apps” downloaded from their servers. The present invention allows for open monetization and thereby offers a wider choice of payment and distribution systems.

In another aspect the present invention suggests to configure the client program as a mobile web browser. Widely available web browsers are e.g. Opera®, Firefox®, Safari® and Internet Explorer®. However, the list of web browsers is not limited to the said examples. Using mobile web browsers offers the advantage that standard programming languages like HTML, which is particularly preferred, as well as CSS and/or JavaScript can be used to develop webpages. At the time of writing this document HTML in version 5 (HTML-5) is the preferred HTML version. However, it will be appreciated that also future releases of the HTML language will be applicable to the invention. Using web browsers as client programs reduces the fragmentation of webpages development and provides synergies across browser platforms.

The present invention also suggests embedding the window representation of the video stream and the augmented reality objects in the webpage as a HTML object.

In order to provide the users of the mobile electronic device with a reliable and comfortable user experience the present invention further suggests that the instructions contained in the webpage cause the processor to check whether the mobile web browser comprises the functionality to have the processor retrieving the video data, the position data, the directional data and the inclination data, and in case of lacking functionality to provide visible warning information in the window of the display of the mobile electronic device. Advantageously, the warning information comprises one of a warning message or information about the necessity for upgrading or changing the web browser installed in the mobile electronic device.

In another aspect of the invention the instructions contained in the webpage cause the processor to toggle the content displayed in the window between the representation of the video stream with embedded augmented reality objects and alternative content such as a map view or an object list.

In yet another aspect of the invention the instructions contained in the webpage cause the processor to zoom the representation of the video stream in the window and to expand the embedded augmented reality objects.

In order to enhance the user experience the present invention further suggests that the instructions contained in the webpage cause the processor to move the representation of the video stream and the embedded augmented reality objects within the window. Additionally or alternatively, the instructions contained in the webpage cause the processor to expand the window to a full-screen mode.

### BRIEF DESCRIPTION OF THE DRAWINGS

FIG. 1 shows a schematic block diagram of a mobile electronic device according to the invention.

FIG. 2 shows a schematic representation of a webpage containing an augmented reality window according to the invention.

FIG. 3 shows another view of the webpage of FIG. 2, wherein the content of the augmented reality window is zoomed.

FIG. 4 shows yet another view of the webpage of FIG. 2, wherein the augmented reality window is expanded to a full screen mode.

FIG. 5 shows yet another view of the webpage of FIG. 2, wherein the augmented reality window is toggled to a map view.

FIG. 6 shows a view of the webpage of FIG. 2 with a warning message.

### DETAILED DESCRIPTION OF THE PREFERRED EMBODIMENT

The present invention will now be explained by way of illustrative embodiments. It is to be understood that these embodiments are presented merely to provide the reader with explanations, but are not intended to limit the scope of protection.

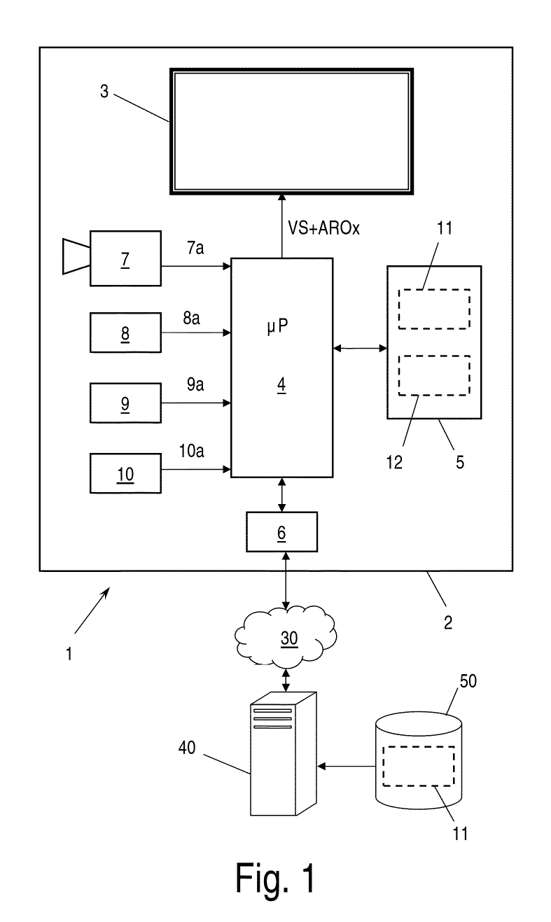

FIG. 1 is a schematic block diagram of a mobile electronic device 1 incorporating the present invention. This mobile electronic device 1 is e.g. configured as one of cellular phone, a portable media player or a handheld computing device. The mobile electronic device 1 comprises a housing 2. Within the housing 2 there is provided a display 3, a processor 4 configured to transmit signals representative of a stream of image data to the display 3, and at least one memory 5 configured to store data and software code to be executed by the processor 4. The memory 5 may comprise random access memory devices (RAM) for storing temporary date and permanent memory devices like EEPROM and/or flash memory devices for long-term storing of operating system code and user software. The mobile electronic device 1 further contains at least one data interface 6 configured to establish data connection to a remote server 40. The data interface 6 may be configured as a wireless and/or wire-bound data interface. The data connection between the mobile electronic device 1 and the server 40 may, for instance, be established via a local area network or a wide area network, such as the Internet 30.

The housing 2 of the mobile electronic device 1 further accommodates a camera 7 configured to generate video data 7a; a position sensor 8, e.g. a GPS module, configured to generate position data 8a; a digital compass 9 configured to generate directional data 9a representative for the compass direction the housing 2 is actually held; and an inclination sensor 10 configured to generate inclination data 10 of the housing 2.

The processor 4 is configured to load a webpage 11 via its data interface 6 from the server 40 into the memory 5 of the mobile electronic device 1. In the present embodiment the server 40 is connected with a data storage device 50 storing the webpage 11 to be loaded into memory 5. The processor 4 of the mobile electronic device 1 is further configured to run a client program 12 that is stored in the memory 5, wherein the client program 12 executes instructions contained in the webpage 11. In the depicted embodiment of the invention the client program 12 executing the instructions of the webpage 11 is configured as a mobile web browser program.

The instructions contained in the webpage 11 cause the processor 4 to retrieve video data 7a from the camera 7, to generate a video stream VS from the retrieved video data 7a and to transmit the video stream VS to the display 3 such that the video stream VS is displayed in a window representation in the display 3. Further, the instructions contained in the webpage 11 cause the processor 4 to retrieve position data 8a from the position sensor 8, to retrieve directional data 9a from the digital compass 9, and to retrieve inclination data 10a from the inclination sensor 10. On the basis of said position data 8a, directional data 9a and inclination data 10a the processor 4 generates augmented reality objects AROx (x=1, 2 . . . ) by using techniques known in the field of “location-based” tracking. These augmented reality objects AROx correspond to real objects and/or sceneries visible in the field of view of the camera 7 at a certain moment in time, which real objects have been determined by means of the applied “location-based” tracking techniques. The augmented reality objects AROx are overlaid onto the recognized real objects in the live camera video stream VS. It is to be understood that the augmented reality objects AROx represent content related to the real objects. By overlaying the visible real objects with the augmented reality objects AROx a window representation of the combined video stream VS plus augmented reality objects AROx is generated, called augmented reality window ARW, that is displayed in a window in the display 3.

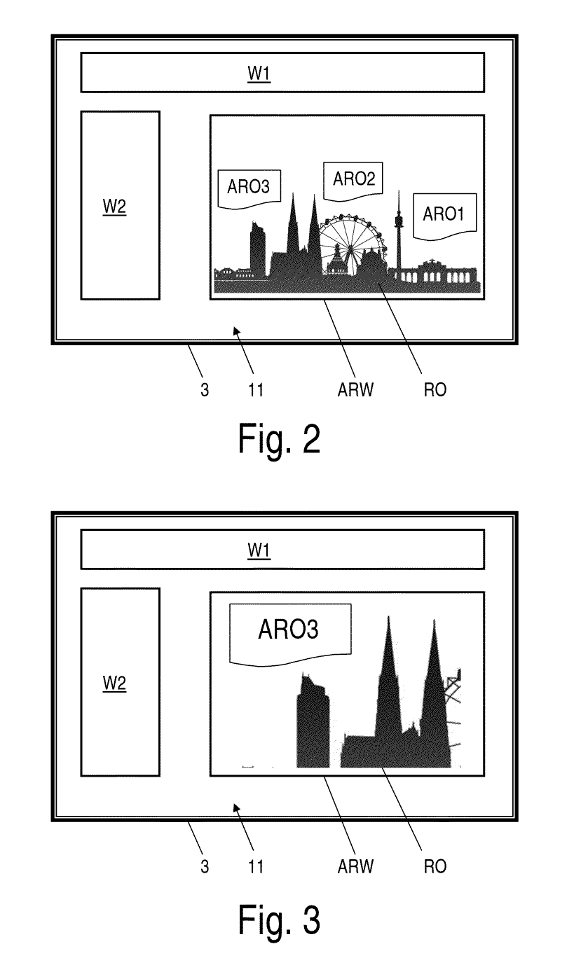

FIG. 2 shows a schematic representation of the webpage 11 as it may be visible to a user in the display 3 of the mobile electronic device 1. It contains the augmented reality window ARW which is composed of a scenery with real objects RO and overlaid content configured as augmented reality objects ARO1, ARO2, ARO3. In FIG. 2 the augmented reality objects ARO1, ARO2, ARO3 are shown merely schematically, they may for instance comprise text elements, 2-dimensional graphical objects and 3-dimensional graphical objects.

It is preferred to embed the augmented reality window ARW in the webpage 11 as a HTML object. Generally, the webpage 11 may comprise HTML code, e.g. HTML-5 code. The webpage 11 contains additional elements W1, W2 configured as HTML elements. It is to be understood that the augmented reality window ARW is movable within the display 3, e.g. by means of a pointing device or by finger movements over the display 3 provided that it is configured as a touch screen. As in ordinary windows when the augmented reality window ARW is moved the visible real objects RO and the overlaid augmented reality objects ARO1, ARO2, ARO3 are moved in synchronism.

The webpage 11 also provides instructions to cause the processor 4 to interact with the camera 7 for zooming the representation of the real objects OR and expanding the embedded augmented reality objects ARO1, ARO2, ARO3 in synchronism with zooming the real objects OR. It is also possible to move the zoomed real objects RO and the expanded augmented reality objects ARO1, ARO2, ARO3 within the augmented reality window ARW, as shown in FIG. 3. By zooming in and out the content of the augmented reality window ARW is brought closer or more remote to the user. By zooming in the camera view is zoomed and all augmented reality objects ARO1, ARO2, ARO3 appear closer and larger in the augmented reality window ARW. In the “zoom/move” mode, the camera view is zoomed and the (virtual) location of the user is moved towards the direction the user is looking at. The position of all augmented reality objects in the augmented reality window ARW is re-calculated according to the new (virtual) location. This mode has the effect that the user actually flies by an augmented reality object ARO1, ARO2, ARO3 if the (virtual) location of the user passes by an augmented reality object ARO1, ARO2, ARO3.

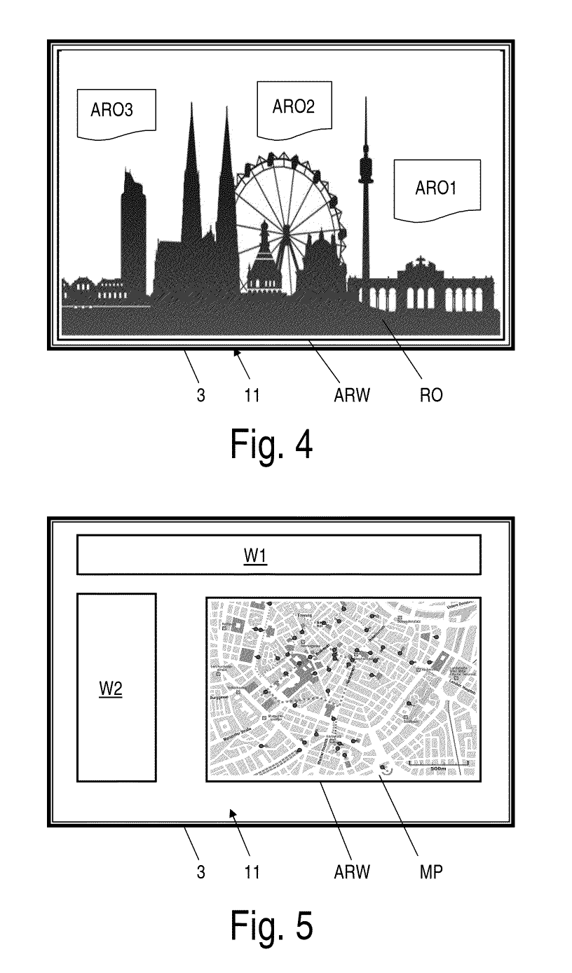

As shown in FIG. 4 the instructions contained in the webpage 11 provide the functionality to cause the processor 4 to expand the augmented reality window ARW to a full-screen mode consuming the whole area of the display.

The instructions contained in the webpage 11 further allow the user to toggle between alternative representations of the augmented reality window ARW. For instance, the user can switch between the representation depicted in FIG. 2 to a view of a map MP, as shown in FIG. 5, or to a listing of the objects (not shown in the drawings).

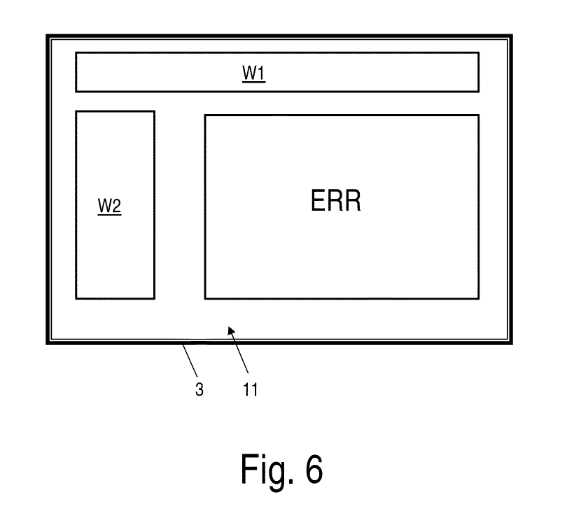

Since it may happen that the client program 12, strictly speaking the mobile web browser installed in the mobile electronic device lacks, some the abilities required by the instructions contained in the webpage 11 the webpage 11 causes the processor 4 to check whether the mobile web browser comprises the functionality for retrieving the video data, the position data, the directional data and the inclination data. When the check reveals that necessary functionality is lacking a visible warning information ERR is displayed in the window, as shown in FIG. 6. This warning information ERR comprises either a warning message or information about the necessity for upgrading or changing the used mobile web browser.

It should be noted that interaction is possible between content within the augmented reality window ARW and other elements W1, W2 of the mobile webpage. For instance, interaction can be initiated by clicks on the elements W1, W2 or actuating control buttons, or by clicking on content within the augmented reality window ARW. Other forms of interaction might be triggered by the augmented reality window ARW, if the user approaches certain real objects (geo-fencing), or as real objects move in and out of the field of vision.

What is claimed is:

1. A mobile electronic device comprising:
a processor;
a display controlled by the processor;
at least one memory configured to store data and software code to be executed by the processor;
at least one data interface configured to establish data connection to a server;
a camera configured to generate video data;
a position sensor, e.g. a GPS module, configured to generate position data;
a digital compass configured to generate directional data representative for the compass direction of the mobile electronic device;
an inclination sensor configured to generate inclination data representative for the mobile electronic device;
wherein the processor is configured to load a webpage from the server into the memory and to run a client program being stored in the memory, which client program executes instructions contained in the webpage, which instructions comprise:
causing the processor to retrieve video data from the camera, to generate a video stream from the retrieved video data and to display the video stream in a representation of a window in the display;
causing the processor to retrieve position data from the position sensor, directional data from the digital compass and inclination data from the inclination sensor and to enhance the window with augmented reality objects derived from the position data, the directional data and the inclination data.

2. The mobile electronic device of claim 1, wherein the client program is configured as a mobile web browser.

3. The mobile electronic device of claim 1, wherein the instructions contained in the webpage comprise HTML code, preferably HTML code in version 5 or higher.

4. The mobile electronic device of claim 3, wherein the window representation of the video stream and the augmented reality objects is embedded in the webpage as a HTML object.

5. The mobile electronic device of claim 2, wherein the instructions contained in the webpage cause the processor to check whether the mobile web browser comprises the functionality for the processor to access the camera, the position sensor, the digital compass and the inclination sensor, and in case of lacking functionality to provide visible warning information in the window.

6. The mobile electronic device of claim 5, wherein the warning information comprises one of a warning message or information about the necessity for upgrading or changing the web browser.

7. The mobile electronic device of claim 1, wherein the instructions contained in the webpage cause the processor to toggle the content displayed in the window between the representation of the video stream with embedded augmented reality objects and alternative content such as a map view or an object list.

8. The mobile electronic device of claim 1, wherein the instructions contained in the webpage cause the processor to zoom the representation of the video stream in the window and to expand the embedded augmented reality objects.

9. The mobile electronic device of claim 1, wherein the instructions contained in the webpage cause the processor to move the representation of the video stream and the embedded augmented reality objects within the window.

10. The mobile electronic device of claim 1, wherein the instructions contained in the webpage cause the processor to expand the window to a full-screen mode.

11. The mobile electronic device of claim 1, wherein the augmented reality objects comprise at least one of text elements, 2-dimensional graphical objects and 3-dimensional graphical objects.

12. The mobile electronic device of claim 1, comprising a housing, wherein the processor, the memory, the at least one data interface, the camera, the position sensor, the digital compass and the inclination sensor are arranged within the housing.

13. A method for visualizing location-based augmented reality content in a display of a mobile electronic device, which mobile electronic device comprises:
a processor;
a display controlled by the processor;
at least one memory configured to store data and software code to be executed by the processor;
at least one data interface configured to establish data connection to a server;
a camera configured to generate video data;
a position sensor, e.g. a GPS module, configured to generate position data;
a digital compass configured to generate directional data representative for the compass direction of the mobile electronic device;
an inclination sensor configured to generate inclination data representative for the mobile electronic device;
wherein the method comprises the steps of:
by means of the processor, retrieving video data from the camera, generating a video stream from the retrieved video data and displaying the video stream in a representation of a window in the display;
by means of the processor, retrieving position data from the position sensor, directional data from the digital compass and inclination data from the inclination sensor and enhancing the window with augmented reality objects derived from the position data, the directional data and the inclination data.

14. The method of claim 13, being implemented by means of program code running in the mobile electronic device.

15. The method of claim 13, comprising the step of toggling the content displayed in the window between the representation of the video stream with embedded augmented reality objects and alternative content such as a map view or an object list.

16. The method of claim 13, comprising the steps of zooming the representation of the video stream in the window and expanding the embedded augmented reality objects.

17. The method of claim 13, comprising the step of moving the representation of the video stream and the embedded augmented reality objects within the window.

18. The method of claim 13, comprising the step of expanding the window to a full-screen mode.

19. The method of claim 13, wherein the augmented reality objects comprise at least one of text elements, 2-dimensional graphical objects and 3-dimensional graphical objects.

20. A webpage being configured to be loaded and executed in a mobile electronic device comprising:
a processor;
a display controlled by the processor;
at least one memory configured to store the webpage, data and software code to be executed by the processor;
at least one data interface configured to establish data connection to a server for retrieving the webpage from the server;
a camera configured to generate video data;
a position sensor, e.g. a GPS module, configured to generate position data;
a digital compass configured to generate directional data representative for the compass direction of the mobile electronic device;
an inclination sensor configured to generate inclination data representative for the mobile electronic device;
wherein the processor is configured to run a client program being stored in the memory, which client program executes instructions contained in the webpage, which instructions comprise:
causing the processor to retrieve video data from the camera, to generate a video stream from the retrieved video data and to display the video stream in a representation of a window in the display;
causing the processor to retrieve position data from the position sensor, directional data from the digital compass and inclination data from the inclination sensor and to enhance the window with augmented reality objects derived from the position data, the directional data and the inclination data.

21. The webpage of claim 20, wherein the instructions contained in the webpage comprise HTML code, preferably HTML code in version 5 or higher.

22. The webpage of claim 20, wherein the window representation of the video stream and the augmented reality objects is embedded in the webpage as a HTML object.

23. The webpage of claim 20, wherein the instructions contained in the webpage cause the processor to check whether the client program is configured as a mobile web browser comprising the functionality for the processor to access the camera, the position sensor, the digital compass and the inclination sensor, and in case of lacking functionality to provide visible warning information in the window.

24. The webpage of claim 23, wherein the warning information comprises one of a warning message or information about the necessity for upgrading or changing the web browser.

25. The webpage of claim 20, wherein the instructions contained in the webpage cause the processor to toggle the content displayed in the window between the representation of the video stream with embedded augmented reality objects and alternative content such as a map view or an object list.

26. The webpage of claim 20, wherein the instructions contained in the webpage cause the processor to zoom the representation of the video stream in the window and to expand the embedded augmented reality objects.

27. The webpage of claim 20, wherein the instructions contained in the webpage cause the processor to move the representation of the video stream and the embedded augmented reality objects within the window.

28. The webpage of claim 20, wherein the instructions contained in the webpage cause the processor to expand the window to a full-screen mode.

29. The webpage of claim 1, wherein the augmented reality objects comprise at least one of text elements, 2-dimensional graphical objects and 3-dimensional graphical objects.
